(19) United States
(12) Patent Application Publication
(10) Pub. No.: US 2014/0198604 A1
(43) Pub. Date: Jul. 17, 2014

(54) BATTER MIXER AND DISPENSER

(71) Applicant: Jobar International, Inc., Carson, CA (US)

(72) Inventor: Man Ying CHAN, Hong Kong (CN)

(73) Assignee: Jobar International, Inc., Carson, CA (US)

(21) Appl. No.: 14/148,514

(22) Filed: Jan. 6, 2014

(30) Foreign Application Priority Data
Jan. 9, 2013 (CN) 2013 30005353.7

(51) Int. Cl. B01F 13/10

(52) U.S. Cl. CPC B01F 13/10
USPC 366/241

(57) ABSTRACT

A batter mixer including a body, a lid coupled to the body, a paddle extending from the lid, a base coupled to the body, an outlet formed through the base, a handle coupled to the body, and a pad coupled to the handle and moveable from a position plugging the outlet to a position of not plugging the outlet.

### CROSS-REFERENCE TO RELATED APPLICATIONS(S)

This Application claims priority to and the benefit of Chinese Application No. 2013 30005353.7, filed on Jan. 9, 2013, the disclosure of which is hereby incorporated by reference in its entirety.

### TECHNICAL FIELD

The present disclosure relates to a batter mixer and dispenser.

### BACKGROUND

Batter mixers such as electric pancake mixers are daily necessities and are widely used. In order to facilitate the use of such mixers, a motor is used to drive an impeller for stirring the batter. However, mixers discharge the batter from a top portion of their body making it inconvenient to use.

### SUMMARY

To solve the above problem, the present disclosure provides a simple structured, easy to use batter mixer and dispenser (referred to for convenience as “batter mixer” or “mixer”).

An example embodiment batter mixer is equipped with body having a base and a top lid. At least one battery and a motor are housed in a housing formed in the lid. A switch button is provided on the lid. A stirring blade or paddle driven by the motor extends from a bottom portion of the housing and is connected to the motor via a shaft. In an example embodiment, the lid bottom is curved or bowl shaped. The body in an example embodiment is cylindrical and has a bowl shaped base that is coupled to or is integral with the body. An opening is formed on the base defining an outlet that is covered by a moveable pad coupled to a handle. The moveable pad moves from a position blocking (plugging) the outlet to a position not blocking at least part of the outlet. A rubber seal is provided around the outlet and creates a seal when the pad in the position blocking or plugging the outlet. A handle equipped with a lever is coupled to the body. The lever is hinged at the top of the handle. The lever is connected at a bottom end to the pad and is spring loaded to urge the pad to a position blocking the outlet. A bottom lid may be provided and covers the bottom of the body below the base.

The example embodiment mixer allows the top lid to be removed from a top end of the body and the ingredients to be mixed to form the batter are placed within the body. The lid including the housing including the battery and motor and the rotating blade coupled to the motor are placed on the top of the body to cover the body. The switch is used to turn the motor on to allow the blade to mix the ingredients to form the batter. When the ingredients are mixed sufficiently forming the batter, the batter may be discharged from the base outlet by pressing on the lever which moves the pad from blocking the outlet. Thus the example embodiment mixer is convenient and practical.

### BRIEF DESCRIPTION OF THE DRAWING

FIG. 1 is a diagram of an example embodiment mixer; in which: 1 is a body; 2 is a base lid; 3 is a top lid; 4, is a battery; 5 is a motor; 6 is a switch button; 7 is a paddle shaft; 8 is a paddle; 9 is curved base; 10 is a rubber material ring seal; 11 is a pad; 15 is an outlet; 12 is a handle; 13 is a lever; and 14 is a spring.

### DESCRIPTION

An exemplary embodiment of the mixer is described below. It should be noted that the mixer of the present invention is not limited only to the example embodiment described below.

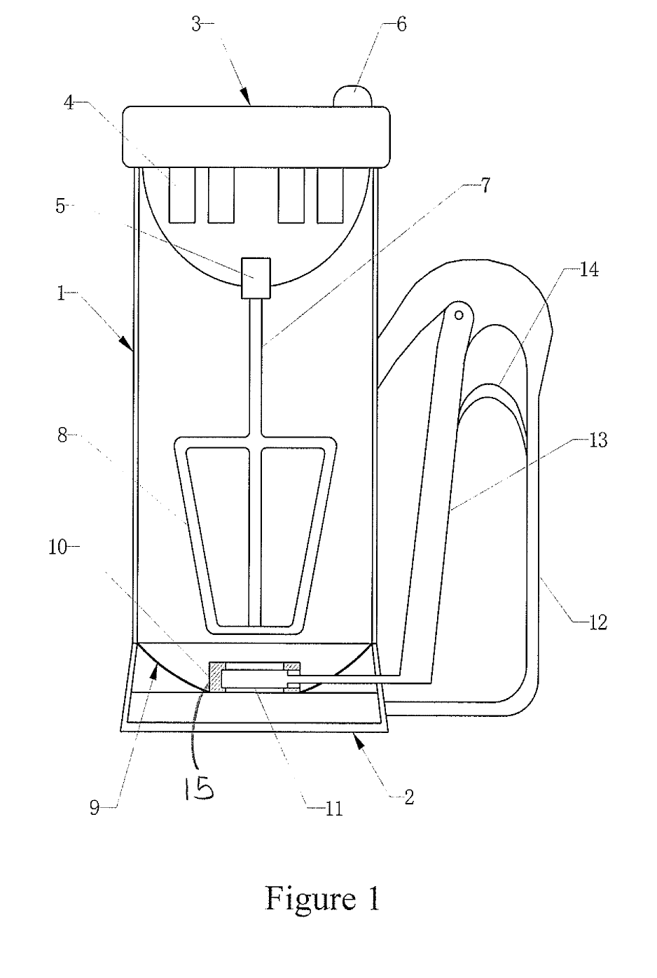

As shown in FIG. 1, is a batter mixer. The mixer, comprises a body (1), a base lid (2), a top lid (3), which houses a battery (4) and a motor (5), a switch button (6) on top of the top lid, a stirring blade shaft (7) is connected to the motor, a stirring blade, or paddle (8) extending from the stirring blade or paddle shaft, and curved base (9) at a bottom portion of the body. An outlet (15) is formed on the curved base (9). A rubber seal (10) is located at a center of the curved base (9) of the mixer surrounding the outlet (15). A pad (11) in an exemplary embodiment made from rubber moves through the rubber seal and into a position blocking (e.g., plugging) the outlet (15). A handle (12) is provided extending from an outer wall of the mixer body (1). A lever (13) is coupled to an inner part of the handle (12). In the shown example embodiment, a top portion of lever (13) is hinged to the inner part of handle (12) and a bottom portion of lever (13) is linked to the pad (11). A spring (14) such a leaf spring is coupled to the handle (12) and the lever (13). A top end of the handle (12) is coupled to an upper portion of the mixer body (1) and a bottom end of the handle (12) is coupled to a bottom portion of the body. Compressing the lever (13) against the handle (12) causes the pad to withdraw from plugging the outlet (15). When the lever is released, the spring (14) causes the lever to pivot away from the handle and to move the pad (11) into a position blocking (i.e., plugging) the outlet.

To use, the ingredients for the batter are placed in the body. The lid with paddle shaft and paddle are then mounted on the top of the body. The switch button is then pressed and the mixing paddle is rotated by the motor to mix the ingredients together.

When the ingredients are mixed sufficiently to form the batter, the switch button is pressed again to stop the mixing. The base lid is removed from the body (if provided and mounted on the body). The lever is then compressed to withdraw the pad from the outlet and the batter discharges from the outlet. Alternatively, the top lid may be removed and the batter may be poured from the top end of the body.

The utility pancake mixer structural design is reasonable, convenient and practical. It should be noted that, for those of with ordinary skill, can make changes and modifications without departing from the scope of the disclosure. And such changes and modifications should be considered as a variant of the present disclosure.

1. A batter mixer comprising:
a body;
a lid coupled to the body;
a paddle extending from the lid in the body;
a base coupled to the body;
an outlet formed through the base;
a handle coupled to the body; and
a pad coupled to the handle and moveable from a position plugging the outlet to a position of not plugging the outlet.

2. The mixer of claim 1 further comprising:
a lever pivotally coupled to the handle and the pad.

3. The mixer as recited in claim 2 further comprising a spring coupled to the lever and the handle for urging the pad into the position plugging the outlet.

4. The mixer of claim 3 further comprising a motor for driving the paddle.

5. The mixer of claim 4 wherein the lid comprises a housing, and wherein the motor and at least a battery are housed in the housing.

6. The mixer of claim 1 further comprising a motor for driving the paddle.

7. The mixer of claim 6 wherein the lid comprises a housing and wherein the motor and at least a battery are housed in the housing.

8. The mixer of claim 1 further comprising a bottom lid for coupling to a bottom of the housing below the base.

9. The mixer of claim 1 further comprising a seal for surrounding at least a portion of the outlet.
